(19) United States
(12) Patent Application Publication
(10) Pub. No.: US 2022/0334058 A1
(43) Pub. Date: Oct. 20, 2022

(54) A SENSOR DEVICE AND METHOD FOR DETECTION OF A COMPONENT IN A FLUID

(71) Applicants: Floria OTTONELLO BRIANO, Stockholm (SE); Carlos ERRANDO HERRANZ, Älvsjö (SE); Kristinn B. GYLFASON, Solna (SE)

(72) Inventors: Floria OTTONELLO BRIANO, Stockholm (SE); Carlos ERRANDO HERRANZ, Älvsjö (SE); Kristinn B. GYLFASON, Solna (SE)

(21) Appl. No.: 17/754,423

(22) PCT Filed: Oct. 1, 2020
(86) PCT No.: PCT/SE2020/050926

§ 371 Date: Mar. 31, 2022

(30) Foreign Application Priority Data
Oct. 4, 2019 (SE) 1930315-5

(51) Int. Cl. G01N 21/41; G02B 6/293; G02B 6/42; G01N 21/39

(52) U.S. Cl. CPC G01N 21/4133; G02B 6/29338; G02B 6/4215; G01N 21/39; G01N 2201/06113

(57) ABSTRACT

A sensor device and a method of analyzing a component in a fluid are described. The sensor device comprises a planar substrate defining a substrate plane, an electromagnetic waveguide forming a waveguide resonator and extending in a length direction in a waveguide resonator plane parallel to the substrate plane, wherein the electromagnetic waveguide is supported on the substrate by a support structure, wherein the electromagnetic waveguide has a width in the waveguide resonator plane in a direction perpendicular to the length direction, and a height out of the waveguide plane in a direction perpendicular to the length direction.

### TECHNICAL FIELD

The invention relates to a sensor device comprising a waveguide resonator for guiding an electromagnetic wave, and to a method of detecting a component in a fluid.

### BACKGROUND ART

Optical sensing using the absorption bands of various gases and fluids in the visible or infrared (IR) wavelength range is an established method.

The absorption bands of gases correspond to variations in the refractive index of the gases and of a fluid containing the gases.

The most commonly used method to detect gases is to measure the imaginary part of the refractive index, that is the optical absorption, of the fluid. The absorption may be measured in cavities with mirrors, so that to achieve an effective interaction length which is longer that the physical size of the cavity. This approach is limited by the optical losses in the mirrors. To make sensitive devices with a long optical path-length, either high quality mirrors must be used or the physical path, and hence the device size, must be long. For many applications, low gas flows and the large volume of the gas chamber limit the response speed of the sensor.

The absorption may alternatively be measured using photonic waveguides which allow a long optical path-length in a small physical volume, and hence a small device size. The probed volume of fluid extends over the whole length of the waveguide, which must be sufficiently long to provide a detection response. For IR, the source may be a broadband thermal light source or a laser. If the source used is a broadband source, to get a spectral resolution, optical spectral analysis is then needed. Detectors can be thermal or semiconductor-based photon detectors.

WO 2017/003353 describes a sensor device for detecting a component in a fluid such as a gas. The sensor device comprises a planar substrate, a waveguide for guiding an electromagnetic wave and a support structure extending from the substrate to the waveguide. A method for detecting a component in a gas comprises the steps of providing the waveguide in contact with the gas, transmitting an electromagnetic wave into a first portion of the waveguide, allowing the electromagnetic wave to interact with the fluid in a region of an evanescent wave of the electromagnetic wave around the waveguide and detecting the electromagnetic wave at a second portion of the waveguide. The component in the gas is determined based on the detected electromagnetic wave at the second portion. The width of the support structure varies along the length direction of the waveguide and the waveguide is of a material of a first composition and the support structure is of a material of a second composition. In this way, the influence of the support structure on the wave guiding properties is decreased. In order to minimize the influence of the support structure on the wave guiding properties and to increase the sensitivity of the sensor device it is advantageous to have the waveguide partly free-hanging.

Measuring the optical absorption of a fluid requires measuring variations in the intensity of an optical signal. This kind of measurement is affected by spurious fluctuations of the intensity, for example due to fluctuations in the output of the light source, and by possible nonlinearities of the light detector. The dynamic range of the measurement is limited by the dynamic range of the detector and by the noise of the optical signal.

The relation between the absorption and the gas concentration is not linear for highly absorbing fluids that absorb more than 10%-30% of the light.

The absorption bands of gases correspond also to variations in the real part of the refractive index, that is the dispersion, of the fluid. The relation between the absorption and the dispersion of gases, i.e., the real part and the imaginary part of the refractive index, is described by the Kramers-Kronig relations.

Resonating cavities are key components of silicon photonics due to their small footprint and ability to filter and route narrowband signals. Photonic ring resonators are a type of cavity. The rings show standing wave resonances when the optical path length of the ring waveguide is a multiple of the excitation wavelength. Thus, by changing the optical length of the ring, e.g., by perturbing the effective refractive index of the waveguide mode, one can tune the resonance wavelength. Tunable ring resonators find applications in integrated optical networks that require selection or dynamic tuning of wavelength channels. Examples of such applications include drift compensation of wavelength division multiplexers (WDMs), optical wavelength routers including reconfigurable optical add-drop multiplexers (ROADMs), broadband switches, four-wave mixers waveguide mirrors, optical angular momentum emitters, and tunable lasers. Certain applications require ring resonators with independent tuning, i.e., low crosstalk between adjacent devices.

Ring resonators tuned by free-carrier injection have achieved high-speed tuning. However, free-carrier absorption results in high optical loss and short wavelength shift, which limits their usefulness for add-drop applications. Thermo-optic tuning of ring resonators has shown large wavelength shift with low optical loss, but high power consumption and thermal crosstalk between neighbouring devices hamper its applicability in densely integrated optical interconnects. Integration of electro-optic materials with low static power dissipation have so far shown low tuning effects, high driving voltages, and optical interference due to fabrication complexity.

MEMS tunable ring resonators are good candidates for wavelength selection due to their low static power dissipation and high optical Q.

Thermo-optically tuned rings show larger FSR and tuning range, at the cost of a power dissipation at least four orders of magnitude above that of electrostatically tuned rings. High power dissipation is also an issue for carrier injection tuning, combined with carrier absorption, that results in a three times larger BW. Among the low-power devices, the integration of electro-optic materials is not CMOS-compatible and presents size limitations. MEMS actuated rings, can provide large tuning ranges and tuning rates.

### SUMMARY OF THE INVENTION

It is an object of the present invention to provide a device, which comprises an electromagnetic waveguide forming a waveguide resonator, with which device at least one of the problems with the prior art is alleviated.

In particular, it is an object of the present invention to provide a sensor device which may be based on the measurement of the dispersion of a fluid rather than its absorption, that is to say that the device may be based on the measurement of a resonance wavelength position rather than on the measurement of the intensity of an optical signal; which device may be smaller than devices based on absorption sensing, and which may be capable of probing extremely small volumes of fluids. Also such a device is not affected by spurious light intensity fluctuations.

Another object of the invention is to provide a method of analyzing a component in a fluid is based on the measurement of the dispersion of a fluid rather than its absorption, that is to say that the device used in the method may be based on the measurement of a resonance wavelength position rather than on the measurement of the intensity of an optical signal; which device may be smaller than devices based on absorption sensing, and which may be capable of probing extremely small volumes of fluids.

The above objects are achieved by a device according to the independent device claim and a method according to the independent method claim.

Further advantages are achieved with the features of the dependent claims.

According to a first aspect of the invention a sensor device is provided which comprises a planar substrate defining a substrate plane, an electromagnetic waveguide forming a waveguide resonator and extending in a length direction in a waveguide resonator plane parallel to the substrate plane, wherein the waveguide is supported on the substrate by a support structure, wherein the waveguide has a width in the waveguide resonator plane in a direction perpendicular to the length direction, and a height out of the waveguide plane in a direction perpendicular to the length direction.

The sensor device according to the invention may be used for detection of a component in a fluid.

The fluid may be a gas but it is also possible that the fluid is a liquid.

In case the fluid is a gas the gas may be a mixture of gases such as air, but it may also be a pure gas. The sensor device may be configured in such a way as to feature at least one resonance in spectral proximity of an absorption line of the component to be detected.

At least one resonance in spectral proximity of an absorption line of the component to be detected may be provided by configuring the waveguide resonator to have at least one resonance in spectral proximity of an absorption line of the component to be detected

The sensor device may comprise means to modify the real part of the effective refractive index of a waveguide mode of the waveguide resonator so that one or more resonances of the sensor device overlap in variable measure with an absorption line of the component to be detected.

The means to modify the real part of the effective refractive index of a waveguide mode of the waveguide resonator may comprise a heater for heating the waveguide resonator.

The means to modify the real part of the effective refractive index of a waveguide mode of the waveguide resonator may comprise a waveguide like structure in proximity to the waveguide resonator and means for adjusting the geometrical relationsship between the waveguide like structure and the waveguide resonator.

The means for adjusting the geometrical relationsship between the waveguide like structure and the waveguide resonator, may comprise a hinged membrane on which one of the waveguide like structure and the waveguide resonator is arranged and means for moving the membrane. The movement of the membrane may be performed with electrostatic or electromagnetic forces.

The waveguide resonator may be constructed from a waveguide loop. A waveguide loop is a waveguide which forms a closed loop for electromagnetic radiation. Such a waveguide may be formed as a closed loop or a loop with one or more gaps in it, wherein the gaps are sufficiently small to allow the electromagnetic radiation to pass.

The waveguide resonator may be a ring resonator. This is a waveguide loop which is essentially circular in form. The continuous bending of the waveguide provides for low losses.

The waveguide resonator may be a racetrack resonator. A racetrack resonator is waveguide loop which contains straight portions. The straight portions makes it easier to adjust the length of the waveguide loop in comparison to a ring resonator.

The waveguide resonator may be a Fabry-Perot type resonator. This is a well-known type of resonator per se. Implementation of such a Fabry-Perot type resonator as waveguide resonator in the sensor device is an alternative to the waveguide loop.

The waveguide resonator may be constructed from a waveguide cavity between two partially reflecting waveguide mirrors. This is usually referred to as a Fabry-Perot interferometer.

The waveguide resonator may be constructed from a waveguide cavity between two partially reflecting waveguide mirrors wherein the mirrors are created by periodic modifications of the waveguide.

The waveguide resonator may have a cladding to protect the waveguide mechanically. The cladding of the waveguide resonator may be removed in parts to reduce material losses and to allow interaction between the evanescent field of the waveguide resonator and any surrounding fluid or solid.

The waveguide resonator may be formed by a ridge waveguide incorporated in a suspended membrane.

The waveguide resonator may support one or multiple waveguide modes.

The waveguide resonator may features multiple resonances.

The sensor device may contain a second electromagnetic waveguide forming a bus waveguide and extending in a length direction in a waveguide plane parallel to the substrate plane is placed close enough to the waveguide resonator so as to achieve electromagnetic coupling between the two. By having such a bus waveguide the coupling of electromagnetic radiation into the waveguide resonator is facilitated, especially when it is in the form of a waveguide loop. The magnitude of close enough depends on the wavelength of the electromagnetic wave and on the shape of the waveguides and of the guided light modes. Longer wavelengths allow a larger distance between the bus waveguide and the waveguide resonator while still allowing the electromagnetic radiation to be coupled. A person skilled in the art would know how to choose the distance in dependence of the wavelength to enable the coupling of the electromagnetic wave from the bus waveguide to the waveguide resonator.

The distance between the bus waveguide and the waveguide resonator may according to an alternative be no more than 1 μm. This is a suitable distance for wavelengths of about 3-5 μm. Some coupling may of course be achieved also with a slightly larger distance, but the coupling efficiency is decreased.

Light may be coupled directly into a Fabry-Perot type resonator. Thus, there would be no need to couple the electromagnetic light from a bus waveguide in the case that the waveguide resonator is a Fabry-Perot type resonator.

Alternatively, light may be coupled into a Fabry-Perot cavity with a side bus waveguide, like the embodiments with the ring resonators.

The bus waveguide may be free hanging along any number of portions along the length direction.

The vacuum wavelength of the guided electromagnetic waves may be within the range of 0.4-100 μm, preferably within the range of 1.2-7 μm. More preferred the wavelength of the electromagnetic wave is within the range of 3-7 μm, or most preferred within the range of 3-5 μm. In the case of measuring the concentration of CO₂ a strong absorption peak may be found at 4.23 μm. An ethanol peak may be found at 3.34 μm, a methane peak may be found at 3.32 μm. Thus, the range of 3-5 μm is suitable for detection of a number of different gases. The height of the waveguide may be smaller than the vacuum wavelength of the electromagnetic wave. This is favourable in order to provide a part of the electromagnetic wave as an evanescent wave outside the waveguide.

The width of the waveguide may be smaller than the vacuum wavelength of the electromagnetic wave. This is favourable in order to provide a part of the electromagnetic wave as an evanescent wave outside the waveguide.

The width to height ratio of the waveguide may be more than 3, preferably more the 5, and more preferably more than 10. By having such a width to height ratio the effect of the sides being perpendicular to the substrate plane is minimized. Due to the manufacturing processes used the quality of the upper and lower surfaces of the waveguide are of a higher quality than the side surfaces. The small area of the side surfaces in relation to the upper and lower surfaces result in lower losses.

The waveguide resonator may be located on a waveguide plane parallel to the substrate plane.

The waveguide resonator may be located on a waveguide plane parallel to and offset from the bus waveguide plane.

The waveguide resonator may be supported on the substrate by a support structure extending from the substrate to the waveguide plane.

The mode volume of a resonant mode of the waveguide resonator may be below 1 mm3, preferably below 100 000 μm3, more preferred below 10 000 μm3, or most preferred below 1000 μm3.

The resonator waveguide may be completely suspended, in which case its bottom surface may not be in contact with any solid material.

The resonator waveguide may be suspended at a distance from the substrate by side support structure.

The side support structure may have the same height as the waveguide.

The side support structure may have a height smaller than the height of the waveguide.

The side support structure may be continuous along the length of the waveguide.

The side support structure may be not continuous along the length of the waveguide, and may comprise more than one supporting sub-element.

The side support structure may be in contact with one an intermediate layer that is also in contact with the substrate, which intermediate layer may comprise one or multiple sublayers of different compositions.

The device layer may be electrically connected to the substrate via conductive materials.

The resonator waveguide may be partially suspended, in which case its bottom surface may be in contact with one or multiple solid materials, which act as bottom support, at least for a portion of the waveguide length.

The resonator waveguide may be fully supported, in which case its bottom surface may be in contact with one or multiple solid materials along the entire waveguide length.

The resonator waveguide may be of a material of a first composition and the support structure may be of the same material.

The resonator waveguide may be of a material of a first composition and the support structure may be of a material of a second composition. The index of refraction of the first material may be higher than the index of refraction in the second material, at the wavelength of the electromagnetic wave.

The resonator waveguide may be of a material of a first composition and the bottom support may be of the same material.

The waveguide may be of a material of a first composition, the support structure is of a material of the first composition, and the substrate is of a material of the first composition.

The waveguide, support structure, and substrate may be made of any permutation of materials of the first second and third composition.

The bottom support may be in contact with both the resonator waveguide and the substrate.

The bottom support may comprise one or multiple layers of different composition.

A resonance wavelength of the waveguide resonator may be intentionally varied, i.e. tuned, by changing the real part of the effective refractive index of a waveguide mode of the waveguide resonator.

A resonance wavelength of the waveguide resonator may be intentionally varied, i.e. tuned, by changing the temperature of the waveguide material.

A resonance wavelength of the waveguide resonator may be intentionally varied, i.e. tuned, by plasma dispersion, i.e. by changing the number of charge carriers in any of the constituent materials of the sensor device.

A resonance wavelength of the waveguide resonator may be intentionally varied, i.e. tuned, by electro-optic effects, such as the Pockels effect and the Kerr effect.

A resonance wavelength of the waveguide resonator may be intentionally varied, i.e. tuned, using phase-change materials.

The sensor device may comprise means to modify the real part of the effective refractive index of a waveguide mode of the waveguide resonator, by changing the temperature of the waveguide resonator.

The device may comprise a heating element in contact with or in proximity of the waveguide resonator.

The device may comprise means to apply a force to a free hanging portion of the waveguide resonator such as to displace any parts of it.

The resonance wavelength of the waveguide resonator may be tuned by displacing the entire or a part of the waveguide resonator.

The displacement of the entire or part of the waveguide resonator may be operated by electrostatic, magnetic, thermo-mechanic, plasma-dispersion, electro-optic, shape-memory alloy-based, and/or piezo-electric based actuation.

The device may comprise means to apply a force to a free hanging portion of the bus waveguide such to displace any parts of it.

The displacement of the entire or part of the bus waveguide may be operated by electrostatic, magnetic, thermo-mechanic, plasma-dispersion, electro-optic, shape-memory alloy-based, and/or piezo-electric based actuation.

The resonance wavelength of the waveguide resonator may be tuned by displacing the entire or a part of the resonator waveguide, to change its optical length. The displacement can be of the resonator waveguide, bus waveguide, but also additional structure(s) located in proximity of the resonator.

The change in optical length may be achieved by changing the propagation length or the effective mode index experienced by the wave.

The displacement of the entire or part of the bus waveguide may be operated by electrostatic actuation.

The electrostatic tuning mechanism can be configured as a capacitor with one partially suspended plate and a static plate, made of different or the same materials as the waveguide. Actuation may be horizontal, vertical, or a combination of both. Actuation may be based on parallel plates, or non-parallel plates.

Comb drives is another alternative. Comb drives are electrostatic MEMS actuators composed of two parts generally shaped like combs with interlocking teeth. Compared to two parallel plates, larger facing surface areas can fit in the same space. The working principle is the same as that of the parallel plate capacitor.

Non-parallel plates may provide advantages such as easy electronic control enabled by linear actuation or CMOS voltage levels, longer tuning (of wavelength or of resonating power, Qfactor).

The electromagnetic wave may be used to detect one or more components in the material surrounding the waveguide. The material surrounding the waveguide may be e.g. a gas or a liquid.

The invention further relates to a gas sensor device comprising a sensor device as disclosed herein for detecting at least one component in gas in contact with the waveguide. The at least one component in gas comprises ethanol, carbon monoxide, carbon dioxide, dinitrogen oxide, water vapor, hydrocarbons, ammonia, chlorofluorocarbons and/or CFS:s.

The sensor device may alternatively be a liquid sensor device comprising a sensor device as disclosed herein for detecting at least one component in liquid in contact with the waveguide. The at least one component in liquid comprises proteins, peptides, nucleic acids, biopolymers, and/or hydrocarbons.

A method of detecting a component in a fluid may be comprising; providing a sensor device, providing the fluid in contact with the waveguide resonator, transmitting an electromagnetic wave into a first portion of the bus waveguide, coupling an electromagnetic wave between the bus waveguide and the waveguide resonator, allowing the electromagnetic wave to interact with the fluid in a region of an evanescent wave of the electromagnetic wave around the waveguide resonator, detecting the electromagnetic wave at a second portion of the bus waveguide, and detecting a component in the gas based on the detected electromagnetic wave.

According to a second aspect of the invention a method is provided for analyzing a component in a fluid comprising; providing a sensor device according to the first aspect, providing the fluid in contact with the waveguide resonator, coupling an electromagnetic wave into the waveguide resonator, allowing the electromagnetic wave to interact with the fluid in a region of an evanescent wave of the electromagnetic wave around the waveguide resonator, detecting the electromagnetic wave circulating in the resonator waveguide, and detecting a component in the gas based on the detected electromagnetic wave.

The fluid may be a gas.

A method of detecting a component in a fluid may be comprising steps wherein the observed quality factor of the waveguide resonator is used as a measure of the concentration of the component in the fluid.

A method of detecting a component in a fluid may be comprising steps wherein the observed resonance position/wavelength of the waveguide resonator is used as a measure of the concentration of the component in the fluid. A method of detecting a component in a solid may comprise; providing a sensor device, providing the solid in contact with the waveguide resonator, transmitting an electromagnetic wave into a first portion of the bus waveguide, coupling an electromagnetic wave between the bus waveguide and the waveguide resonator, allowing the electromagnetic wave to interact with the solid in a region of an evanescent wave of the electromagnetic wave around the waveguide resonator, detecting the electromagnetic wave at a second portion of the bus waveguide, and detecting a component in the gas based on the detected electromagnetic wave.

A method of detecting a component in a solid may be comprising steps wherein the observed quality factor of the waveguide resonator is used as a measure of the concentration of the component in the solid.

A method of fabricating the sensor device may be, comprising: providing a wafer, fabricating the waveguide in the wafer, fabricating the waveguide resonator in the wafer, and fabricating the support structure in the wafer.

A method of fabricating the sensor device may be, comprising: providing a wafer comprising a substrate layer, an intermediate layer and a device layer, fabricating the waveguide and waveguide resonator in the device layer, and fabricating the waveguide support structure and waveguide resonator support structure in the intermediate layer, wherein the substrate layer forms the substrate of the device.

A method of fabricating the sensor device may include steps wherein the waveguide is formed in the device layer by etching, and wherein the support structure is formed in the intermediate layer by etching the intermediate layer under the waveguide.

A method of fabricating the sensor device may include steps wherein the waveguide is formed in the device layer by etching, and wherein the support structure is formed in the intermediate layer by etching the intermediate layer under the waveguide resonator.

A method of fabricating the sensor device may include steps wherein the wafer is a SOI wafer comprising a silicon substrate, a silicon dioxide layer, and a silicon device layer, wherein the silicon substrate of the SOI wafer corresponds to the substrate layer, the silicon dioxide layer of the SOI wafer corresponds to the intermediate layer, and the silicon device layer of the SOI wafer corresponds to the device layer.

A method of fabricating the sensor device may include steps wherein the waveguide is protected from etching, and wherein the support structure is formed after fabricating the waveguide.

A method of fabricating the sensor device may include steps wherein the support structure is formed before fabricating the waveguide.

A method of fabricating the sensor device may include steps wherein the waveguide is protected from etching by an etch stop material.

A method of fabricating the sensor device may include steps wherein the waveguide is protected from etching by doping.

Lists of materials for the different layers

In the following lists of suitable materials for the different layers will displayed.

The material in the waveguide, i.e. device layer, may be chosen from the following materials:
Silicon
Silicon Germanium
Germanium
Silicon Nitride
Aluminum Nitride
III-V materials, such as GaAs, InP, InGaAs, and InGaP
Diamond
Sapphire
Barium Titanate
Lithium niobate and other nonlinear materials
Piezoelectric materials
Polymers

The material in the substrate may be chosen from the following materials:
Silicon
CMOS
Glass (SiO2-based glasses)
Germanium
Polymer
Sapphire
III-V materials, such as GaAs, InP, InGaAs, InGaP, etc.
Diamond
Metals
Silicon carbide

The material between the substrate and the device layer might be a combination of different materials stacked horizontally or vertically. These different materials may be chosen from the following materials:
Polymer
Metals (TiW, Ni, Au, W, Al, Cr, Ti, Cu, Ag)
Dielectrics (SiO2, SiN, Al₂O₃)
Semiconductors such as, e.g., Si, SiGe.

The invention is not limited to the described embodiments but may amended in many ways without departing from the scope of the invention which is limited only by the appended claims.

### BRIEF DESCRIPTION OF THE DRAWINGS

FIG. 1 shows imaginary (top) and real (bottom) parts of the refractive index of 0.1%, 0.5%, and 1% CO2 in N2 at room temperature and atmospheric pressure

FIG. 2 shows SEM images of

a: a fabricated racetrack resonator and bus waveguide;
b: close-up view of the suspended ridge waveguide, and
c: in-coupling waveguide facet
d: Cross-sectional FEM simulation of the waveguide, displaying the electric field profile of the low-confinement fundamental TE mode
e: Schematic of a setup used for characterization of the resonator and CO2 sensing.

FIG. 3 shows a transmission spectra for the ring resonator waveguide and for a reference waveguide. The wavelength difference between the two resonance peaks indicates a free spectral range, FSR, of 6.6 nm.

FIG. 4a shows the tuning of a ring resonator's resonance in proximity of a CO2 absorption line. The tuning is performed thermally, and each curve is the ring resonator's transmission measured at different chip temperature.

FIG. 4b displays the resonance position as a function of temperature, measured from the transmission spectra shown in FIG. 4a. The measured thermal tuning rate of the resonator is 0.18 nm/K.

FIG. 5 displays the measured resonance wavelength shift at different initial resonance positions (in N2) relative to the CO2 absorption line position, for the three tested CO2 concentrations. The lines show the simulated refractive index change due to the three CO2 concentrations.

FIG. 6a illustrates a high-confinement strip waveguide.

FIG. 6b illustrates a low-confinement strip waveguide.

FIG. 6c illustrates a low-confinement suspended strip waveguide.

FIG. 6d illustrates a low-confinement rib waveguide.

FIG. 7 illustrates a low-confinement strip waveguide.

FIG. 8 illustrates a sensor device with a broadband light source.

FIG. 9 illustrates the principles behind the sensor device in FIG. 8.

FIGS. 10a-c illustrate the principle behind tuning of the ring resonator and sensing with the ring resonator.

FIG. 11 illustrates how the effective refractive index of a ring resonator may be adjusted by mechanically moving the ring resonator in relation to a second waveguide.

FIG. 12 illustrates a sensor device comprising a plurality of ring resonator.

FIG. 13 shows a sensor device according to an alternative embodiment of the present invention.

FIG. 14a-c illustrates sensor devices according to alternative embodiments.

FIG. 15a-i illustrates different examples of coupling of electromagnetic waves.

FIGS. 16a-b illustrates a sensor device according to an alternative embodiment.

### DETAILED DESCRIPTION

We demonstrate on-chip molecular fingerprinting by refractive index sensing in the mid-IR using a thermally tunable suspended silicon racetrack microring resonator. We demonstrate CO2 sensing down to 1000 ppm at 4.23 μm wavelength. Our approach provides an alternative method for absorption measurements of molecular fingerprints, in particular trace gases.

The so called molecular fingerprint region of the electromagnetic spectrum contains the sharp optical absorption lines associated with the fundamental vibrational and rotational modes of small molecules. The uniqueness of these spectral lines, located at mid-infrared wavelengths, enables molecular identification with high specificity.

Conventional low-cost sensors leveraging this information measure the transmission of light through the sample of interest at a single or a few wavelengths. This method is widely used for sensing of trace gases such as CO2, with important applications in agriculture, industry, and climate science. However, since absorption based gas measurements rely on the determination of optical intensity, they are sensitive to fluctuations in the light source emission and coupling, in particular if only one wavelength is used, and are difficult to miniaturize since a multipass gas cell with mirrors is needed to increase effective path length.

In contrast, refractive index sensing based on tracking the resonance wavelength of integrated optical resonant cavities is much less sensitive to such variations, and very low detection limits in small sensing volumes (below 1 μm3) are regularly reported for sensors operating in the near-infrared, even down to single biomolecule detection [2]. However, this near-infrared detection is typically not specific, since the refraction is a broadband effect and not molecule specific. This drawback has been circumvented for detection of certain biomolecules using surface functionalization, but this approach is complex and specific to biomolecules, for which evolution has developed very specific binding mechanisms. In the mid-infrared, however, the strong variations of absorption give rise to sharp transitions in the real part of the refractive index of gases, as evident from the Kramers-Kronig relations [3].

Here, we show a gas sensor leveraging this physical link between absorption and refractive index to combine the selectivity of absorption spectroscopy with the sensitivity of refractive index sensing. We demonstrate this sensing principle by performing on-chip absorption spectroscopy of CO2 using a mid-infrared microring resonator refractive index sensor.

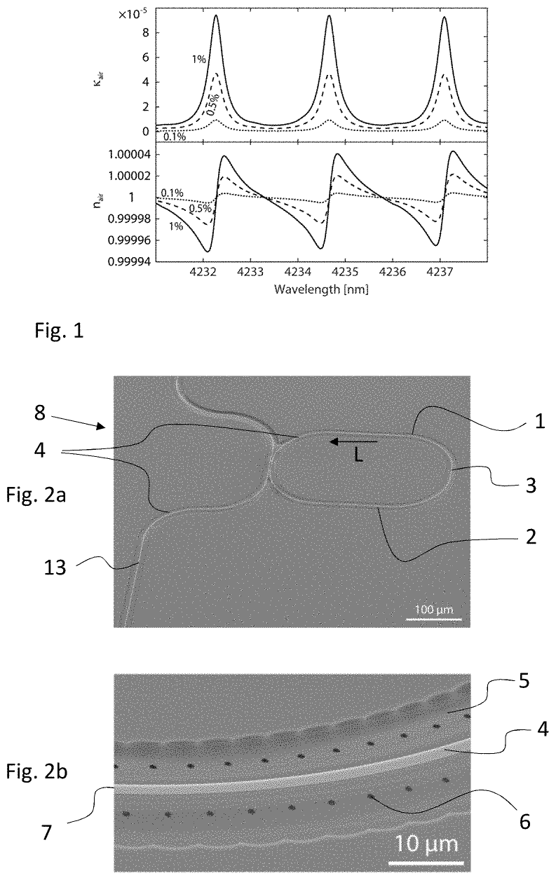

FIG. 1 shows imaginary (top) and real (bottom) parts of the refractive index of 0%, 0.1%, 0.5%, and 1% CO2 in N2 at room temperature and atmospheric pressure. The imaginary part is from HITRAN. The real part is calculated from the imaginary part by the Kramers-Kronig relation.

The Kramers-Kronig relations describe the physical link between the real and imaginary parts of the refractive index of a material. Using these relations, one can find that the strong absorption lines within the fingerprint region result in significant variations of the real part of the refractive index for the wavelengths where the slope of the absorption peaks is highest.

The general technique of measuring variation of the real part of the refractive index for quantification is referred to as dispersion spectroscopy, and with the recent development of tunable quantum cascade lasers operating in the mid-IR, there has been a growing interest in this approach in recent years, but so far only free-space experiments have been reported

We can observe a refractive index change up to 3×10⁻⁵ for 1% CO2. This refractive index change is about two orders of magnitude above the detection limit (DL) of cavity-based refractive index sensors such as microring resonators, with commonly reported DLs below 10⁻⁶ [8].

A microring resonator is formed by a closed-loop waveguide evanescently coupled to an adjacent bus waveguide. If placed close enough, light from the bus waveguide couples into the ring, and, for certain wavelengths, interference in the coupling region leads to resonances, visible as dips in transmission measurements.

The position and shape of these resonance peaks are highly sensitive to changes in the optical properties of the waveguide. For example, increased absorption along the ring waveguide, i.e. a larger imaginary part of the waveguide mode index, leads to a wider resonance bandwidth, while a change in the real part of the waveguide mode index results in spectral shift of the resonance.

Microring resonators for mid-IR wavelengths, and low confinement resonators, in particular, have scarcely been reported, because common waveguide materials suffer from high absorption in that wavelength range. For example, silicon dioxide (SiO₂) is an ubiquitous near-infrared waveguide cladding material, but strongly absorbs in the mid-IR, causing high waveguide losses and thus limiting the waveguide propagation length. This limitation has been circumvented by strongly confining the light inside the waveguide using large-core and multimode waveguides. Devices based on these configurations have been reported using silicon on insulator (SOI), silicon on sapphire (SOS), silicon on nitride (SON), germanium, and chalcogenides. However, only a few of these devices work at wavelengths longer than 3 μm and, most importantly, the small evanescent field of these waveguides makes them unsuited for sensing applications. Nevertheless, absorption spectroscopy of 5000 ppm nitrous oxide at 4.45 μm wavelength using a SOS ring resonator has been reported. Sensing was demonstrated by analyzing the change in resonance bandwidth, and hence the Q factor, of microring resonances aligned to N2O absorption lines. To overcome the limitations caused by cladding materials, suspended waveguides have been recently introduced. Such waveguides potentially allow a low confinement of the light modes, and therefore a high external confinement factor and sensitivity to the analyte.

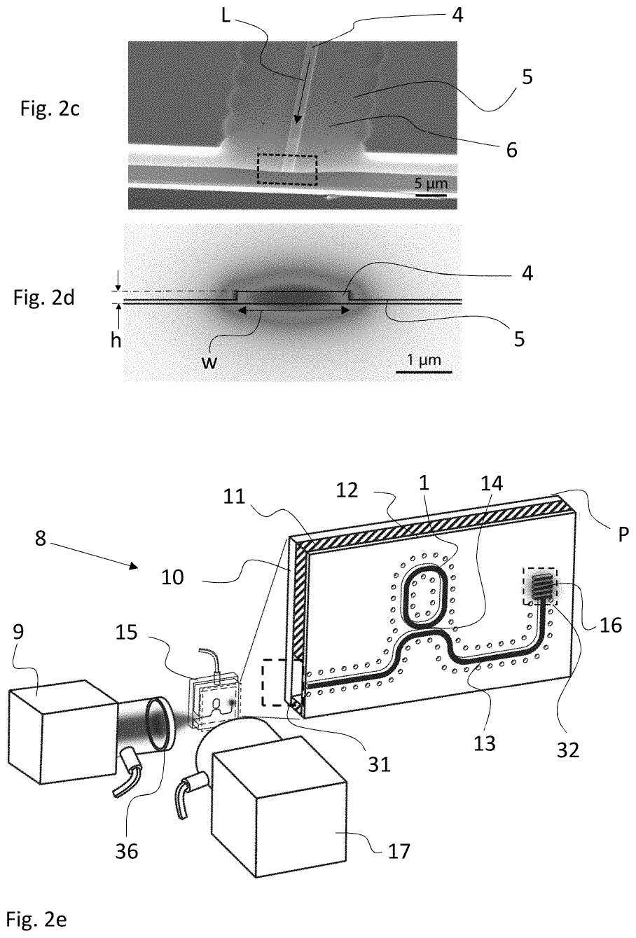

FIG. 2a shows SEM images of a sensor device 8 according to an embodiment of the invention with a waveguide resonator 1, in the form of a racetrack resonator, and a bus waveguide 13. The ring resonator 1 extends in a length direction L and has straight portions 2 between the curves 3. FIG. 2b is a close-up view of the suspended ridge waveguide 4 in the racetrack resonator. FIG. 2c shows an in-coupling waveguide facet 7. The rib waveguide 4 is on a silicon membrane 5. Etch holes 6 can be seen in the silicon membrane 5. The rib waveguide 4 and the silicon membrane has been underetched through the etch holes 6. In FIGS. 2b and 2 c it is possible to see, through the silicon membrane 5, the cavity formed by etching the SiO2 BOX layer through the etch holes. FIG. 2d illustrates a cross-sectional FEM simulation of the ridge waveguide 4, displaying the electric field profile of the deconfined fundamental TE mode. FIG. 2e illustrates a schematic of the sensor device 8 in a setup used for characterization of the resonator and CO2 sensing. The sensor device 8 is illuminated by a mid-IR laser 9 onto the in-coupling facet 7. The sensor device 8 comprises a silicon substrate 10 onto which a silicon dioxide box layer 11 and a silicon device layer 12 are arranged. The substrate defines a substrate plane P. The bus waveguide 13 and the ring resonator 1 are arranged as ridge waveguides in the silicon device layer 12. In the illustrated embodiment the waveguide has a height of 220 nm and the racetrack resonator 1 has a length of 935 μm. The racetrack resonator 1 is arranged close to the bus waveguide 13 at a coupling gap 14. The coupling gap is 14 is 1 μm. i.e., distance between the bus waveguide 13 and the racetrack resonator is 1 μm at the coupling gap 14. The sensor device 8 is arranged on a Peltier element 15. The temperature of the sensor device 8 may be varied by varying the current to the Peltier element 15. The bus waveguide 13 terminates in a diffractive surface grating coupler 16. A mid-IR camera 17 is arranged to capture the light emitted from the diffractive surface grating coupler 16. A source 31 of electromagnetic radiation may alternatively be placed on the substrate 10, i.e., integrated on the sensor device 8. A detector 32 of electromagnetic radiation may be placed on the substrate, i.e., integrated in the sensor device 8.

The above presented sensor device comprises a suspended silicon mid-IR microring resonator, i.e., the racetrack resonator 1, whose resonance wavelength can be efficiently tuned by temperature, due to the high thermo-optic coefficient of silicon.

By scanning the ring resonance across the CO2 absorption peak at 4234.7 nm wavelength, we measure the refractive index dispersion of the gas cladding containing 0.1%, 0.5%, and 1% CO2 diluted in N2. For our experiments, we focus on the fundamental absorption band of CO2 around 4.3 μm wavelength. This absorption band does not overlap with the absorption spectra of other constituents normally present in air, most notably water vapor, and thus allows for highly specific CO2 sensing.

The racetrack resonator 1, shown in FIG. 2 (a-c), consists of a 935 μm long Si ridge waveguide on a Si membrane suspended in air, 3 μm above the handle substrate, i.e., the silicon substrate 10. The waveguide is 220 nm thick and 2 μm wide, and the supporting membrane is 70 nm thick. The bus waveguide 13 has the same characteristics and is separated from the ring by a coupling gap of 1 μm, and terminates in the diffractive surface grating coupler 16.

The waveguide is single mode at 4.23 μm wavelength, and we use its fundamental quasi-TE mode (FIG. 2d), which features an evanescent field ratio (EFR) of 67.1% and an external confinement factor G of 50.0%. See [23, 24] for a discussion of these two descriptions of confinement.

The device was fabricated starting from a commercial silicon-on-insulator (SOI) substrate with a 220 nm Si device layer and a 3 μm SiO2 buried oxide layer. The waveguide was patterned by electron-beam lithography and a timed partial dry etching of the Si device layer. A second lithography step and through dry etching of the Si layer formed holes through which the buried SiO2 was removed by hydrofluoric acid wet etching. Finally, we cleaved the substrate to form a waveguide facet for light in-coupling.

We optically characterized our ring resonator with the setup shown in FIG. 2 (e). We coupled 4.24 μm continuous-wave linearly polarized light from a distributed-feedback quantum cascade tunable laser (MLQD4232, Thorlabs, USA) with single wavelength emission into the waveguide by focusing it onto its input facet with an aspheric lens with a focal length of 4 mm (Black DiamondTM-2). The ring resonator chip was placed inside a steel case equipped with a Peltier cooler for temperature regulation, a gas inlet and outlet for environmental control, and a mid-IR-transparent window for visualization. We observed the surface of the waveguide chip with a mid-IR camera (A6700sc, FLIR, USA) furnished with a cooled InSb-detector and a 1× macro lens. The camera aided the alignment of the waveguide input to the focused light for in-coupling, detected the light transmitted through the waveguide to the output grating coupler, and simultaneously measured the temperature of the chip.

During the gas measurements, we alternately injected N2 and CO2 diluted in N2 into the chip case in 1 min intervals, while the free-space paths before and after the chip box were continuously flushed with N2.

FIG. 3 displays the resonator's transmission, as well as the transmission through a reference waveguide without any ring resonator, both measured in an N2 atmosphere using the camera, as well as the laser output power spectrum measured with a free space power meter. The observed transmission dips for the laser output and the reference waveguide are caused by absorption by residual atmospheric CO2 present along the optical path despite the N2 flushing. In addition to those absorption dips, the resonator waveguide presents additional resonance dips, with a free spectral range (FSR) of 6.6 nm, which agrees well with finite element (FEM) eigenmode simulations of our ring waveguide, and a coupled quality factor Q of 8000. The transmitted power for the laser output, the reference waveguide, and the ring resonator are shown with the lines as denoted in FIG. 3.

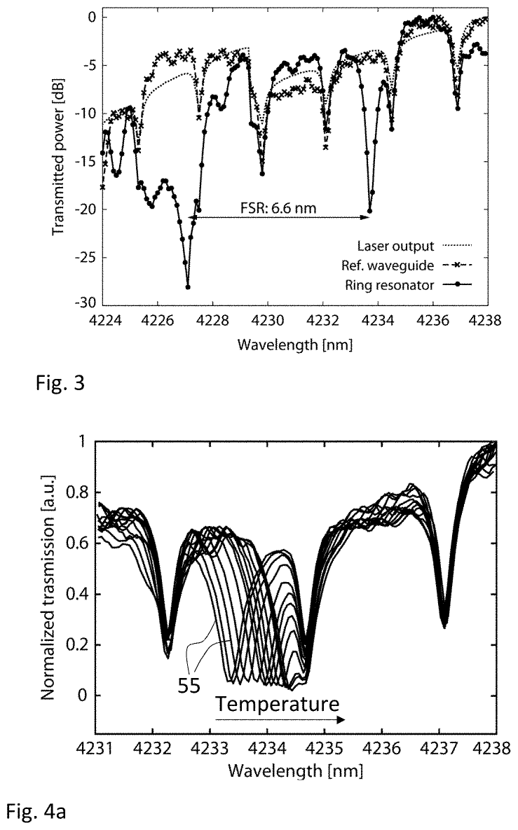

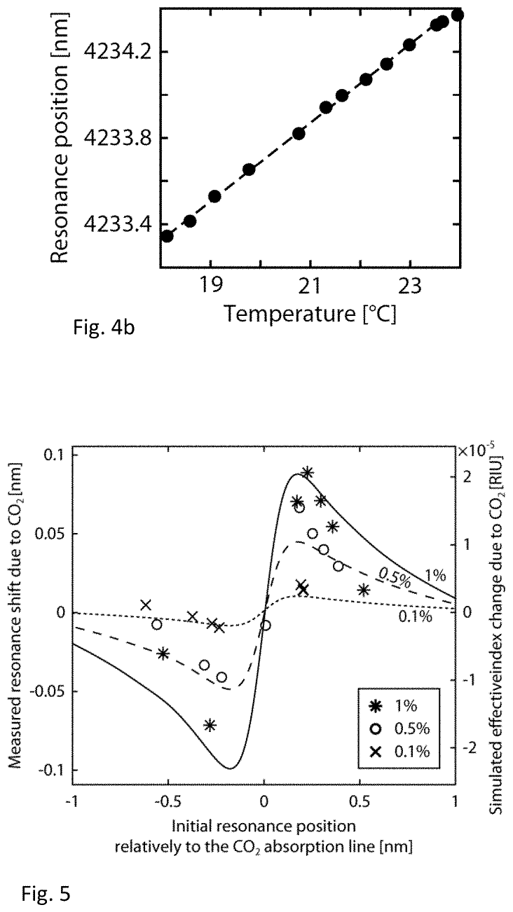

FIG. 4a shows the thermal tuning of the ring resonator resonance. Each curve 55 is measured at different chip temperature, as the ring resonance is scanned over a CO2 absorption dip by thermal tuning. As can be seen in FIG. 4a the position of the central CO2 absorption peak moves to the right, i.e., to higher wavelengths, with an increasing temperature. The measured thermal tuning rate of the resonator is 0.18 nm/K. By varying the temperature of the resonator chip using the Peltier element 15 (FIG. 2e), we scan the resonance over a CO2 absorption dip and, thus, vary the overlap between the two dips. As can be seen in FIG. 4b the resonance wavelength varies with temperature with a tuning rate of 0.18 nm/K.

Using the reported thermo-optic coefficient of silicon at 4 μm wavelength of 1.7×10-4 K−1, and the simulated internal confinement factor ∂neff/∂nSi=0.7 and group index ng=2.9 for our waveguide, the expected tuning rate is 0.17 nm/K.

In our gas sensing experiments, we injected CO2 in concentrations of 0.1%, 0.5%, and 1% in N2, by alternatively switching between CO2 dilutions and pure N2 in 1 min intervals. For each gas concentration and Peltier temperature setting, we swept the laser wavelength and measured the transmission spectra of the device. The measured spectra were then fitted using a double-Lorentzian curve to find the ring resonance position relative to the CO2 absorption dip.

FIG. 5 displays the measured and (provisional) predicted resonance wavelength shift at different initial resonance positions (in N2) relative to the CO2 absorption line position, for the three tested CO2 concentrations.

We observe that our measured resonance wavelength shift follows the trend of theoretical effective index change for our waveguide geometry, according to finite-element method simulations.

We therefore conclude that we successfully measure gas concentrations down to 1000 ppm, i.e. 5 times lower than previous trace gas sensing reports based on microring-enhanced absorption sensing.

We highlight the very small gas volume sampled above the ring in this measurement, below 2000 μm³, based on the evanescent field decay rate and the ring circumference. From the ideal gas law, we can thus estimate that at the lowest detected concentration, we are probing only about 10⁶ CO2 molecules. Moreover, in contrast to absorption-based sensing, our system enables sensing of different concentrations over a large dynamic range using a single-wavelength laser by positioning the laser in the highest refractive index peak and tuning the ring to higher or lower sensitivity.

In summary, we have demonstrated on-chip molecular fingerprinting by refractive index sensing in the mid-IR. We used a thermally tunable mid-IR suspended silicon racetrack microring resonator to demonstrate CO2 sensing down to 1000 ppm at 4.23 μm wavelength. Our approach provides an alternative method for absorption measurements of molecular fingerprints, in particular trace gases.

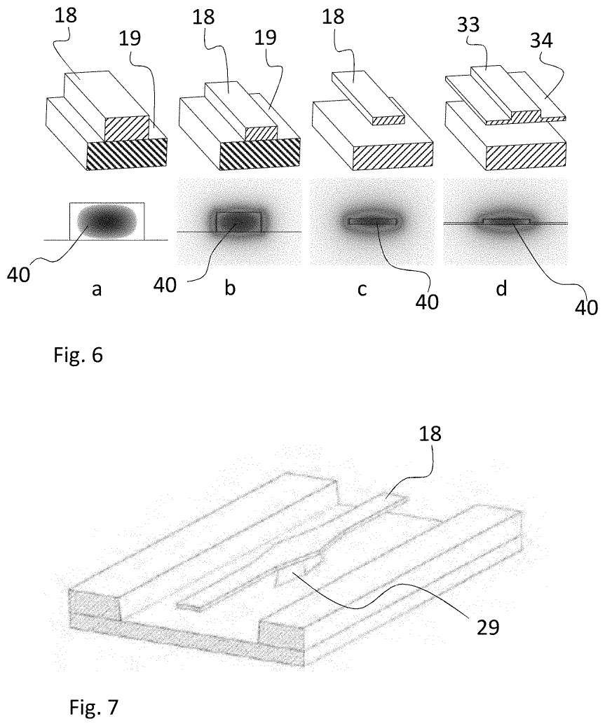

FIG. 6a illustrates a high-confinement strip waveguide 18 which is an alternative to the ridge waveguide 4 shown in FIGS. 2c and 2d. The strip waveguide 18 has dimensions such that most of the electromagnetic wave is confined in the strip waveguide. This results in a limited interaction between the electromagnetic wave guided by the strip waveguide 18 and the surrounding fluid. The strip waveguide 18 is arranged on a cladding 19.

FIG. 6b illustrates a low-confinement strip waveguide 18 which is an alternative to the ridge waveguide 4 shown in FIGS. 2c and 2d. The strip waveguide 18 has dimensions such that an essential part of the electromagnetic wave is guided as an evanescent wave by the strip waveguide. This results in a larger interaction between the electromagnetic wave guided by the strip waveguide 18 and the surrounding fluid, in comparison to the corresponding interaction with the strip waveguide shown in FIG. 6a. The strip waveguide 18 is arranged on a cladding 19.

FIG. 6c illustrates a low-confinement suspended strip waveguide 18. The strip waveguide 18 in FIG. 6c may be suspended on pillars such as the pillar 29 as is shown in FIG. 7. The strip waveguide 18 is free hanging on both sides of the pillar 29. The strip waveguide 18 has dimensions such that an essential part of the electromagnetic wave is guided as an evanescent wave by the strip waveguide. This results in a larger interaction between the electromagnetic wave guided by the strip waveguide 18 and the surrounding fluid, in comparison to the corresponding interaction with the strip waveguide shown in FIG. 6a and FIG. 6b.

FIG. 6d illustrates a low-confinement rib waveguide 33 which is similar to the strip waveguide in FIG. 6c but that is suspended on a membrane 34.

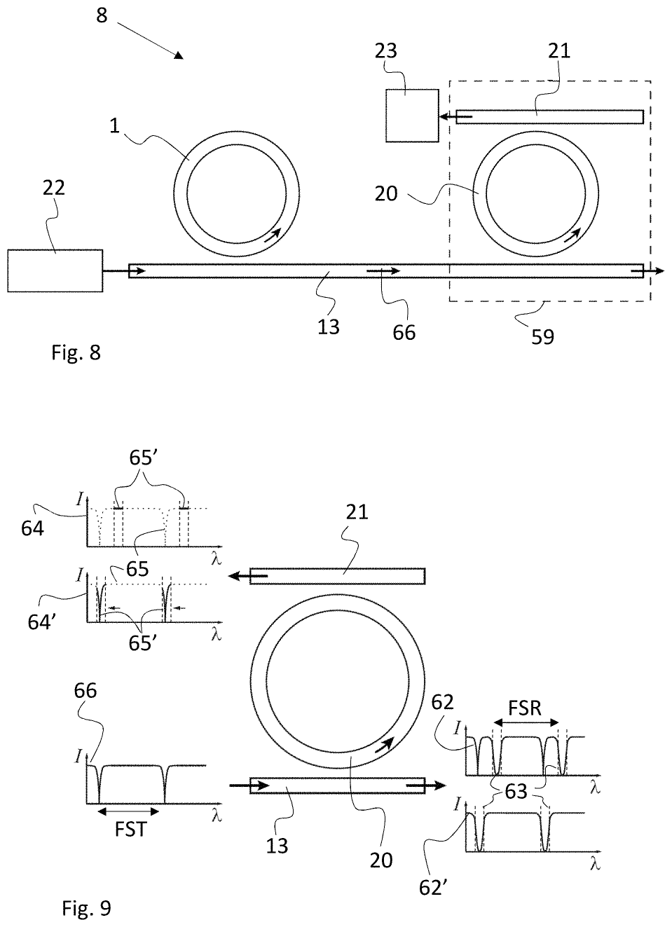

FIG. 8 illustrates, in a top view, a sensor device 8 according to an alternative embodiment of the present invention. The sensor device 8 comprises a bus waveguide 13 and a sensing waveguide resonator 1 in the form of a ring waveguide. The sensor device also comprises a filter waveguide resonator 20 in the form of a second ring waveguide and a detection waveguide 21. In the arrangement shown in FIG. 8 a broadband light source 22 is used and emits light into the bus waveguide 13. The light is coupled to the sensing waveguide resonator 1 in dependence of the wavelength. The wavelength that is coupled is dependent of the length and effective refractive index of the waveguide resonator 1. The effective refractive index of the sensing waveguide resonator 1 is in turn dependent on the fluid surrounding the sensing waveguide resonator 1. The light that is not coupled into the sensing waveguide resonator 1 is passed on in the bus waveguide 13 as passed light 66. Some of the light will be coupled into the filter waveguide resonator 20 in dependence of the wavelength of the electromagnetic wave. The wavelength that is coupled into the filter waveguide resonator 20 is dependent of the length of the filter waveguide resonator 20 and the effective refractive index of the filter waveguide resonator 20. The effective refractive index is in turn dependent on the tuning of the filter waveguide resonator 20. The filter waveguide resonator 20 may be tuned by, e.g., the temperature of the filter waveguide resonator 20. Some of the electromagnetic wave will then be coupled into the detection waveguide 21 and may then be detected by the detector 23. The detected wavelength may be scanned by, e.g., scanning of the temperature of the filter waveguide. The dashed line 59 delimits the bus waveguide 13, the filter waveguide 20 and the detection waveguide 21, which will be explained in FIG. 9.

FIG. 9 illustrates the coupling from the bus waveguide 13 to the filter waveguide 20 and to the detection waveguide 21. The input light 66 is the passed light that has passed the sensing waveguide resonator 1. Absorption peaks in the input light 66 are separated with the free spectral range, FST, of the sensing waveguide resonator 1. Depending on the tuning of the filter waveguide resonator 20 different wavelengths will be coupled from the bus waveguide 13 to the detection waveguide 21 via the filter waveguide 20. The two spectra 62, 62′, shows the output light from the bus waveguide 13. The top spectra 62 illustrate the case of not tuned filter waveguide resonator. The bottom spectra 62′ illustrate the case of tuned filter waveguide resonator. The vertical dashed lines 63 delimit the portions of the spectrum that are coupled from the bus waveguide 13 to the detection waveguide 21 via the filter waveguide resonator 20. The free spectral range, FSR, of the filter waveguide resonator 20 may or may not be equivalent to the FST of the sensing waveguide resonator 1. At the detection waveguide 21 port and of the bus (through) waveguide 13 port, the top transmission spectra 64 illustrate the case of not tuned filter waveguide resonator. The bottom spectra 64′ illustrate the case of tuned filter waveguide resonator. The arrows indicate the shift due to the tuning of the filter. The dotted lines 65 indicate the input light. The solid lines 65′ indicate the transmitted light at the corresponding waveguide port. By continuous tuning it is possible to scan a wavelength range. The output light 64 from the bus waveguide 13 is missing the wavelengths that have been coupled from the bus waveguide 13 via the filter waveguide to the detection waveguide. The missing wavelengths are separated by the free spectral range, FST, of the filter waveguide resonator 1. By scanning the tuning of the filter waveguide 20 as described above it is possible to detect the position of the resonance of the waveguide resonator 1 and thereby to detect the concentration of the component in the fluid.

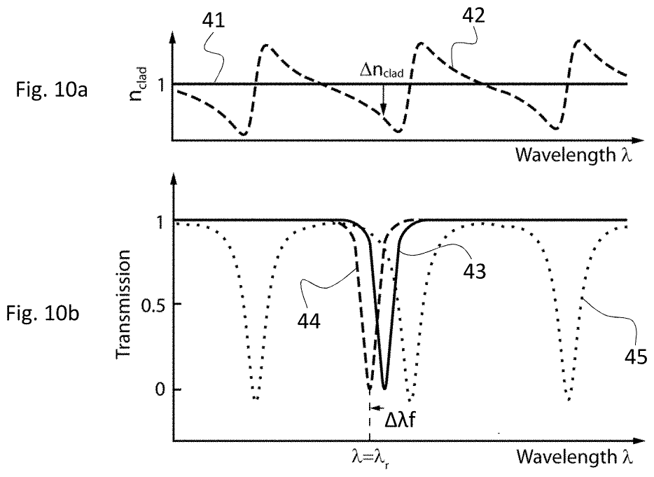

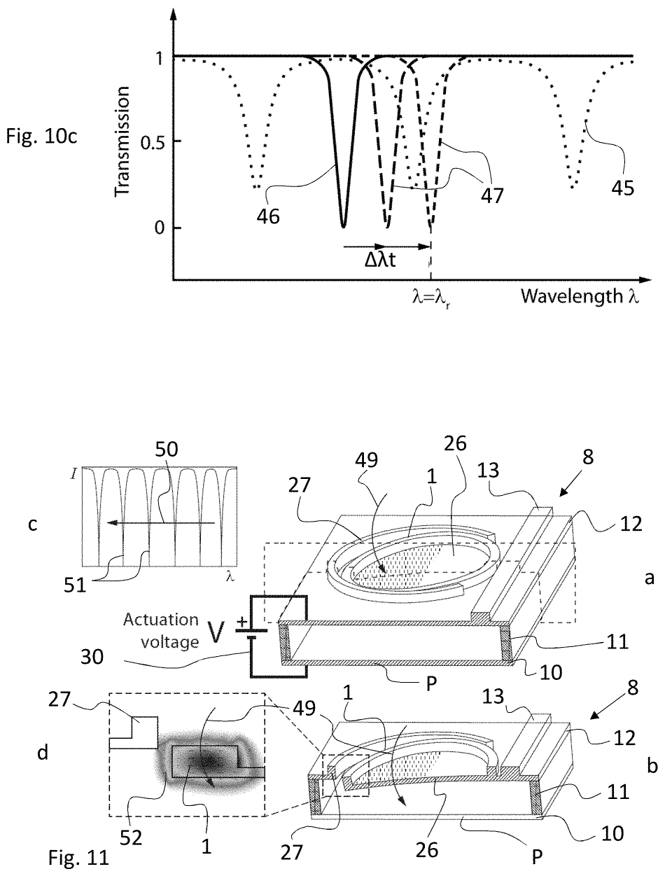

FIG. 10a illustrates the refractive index for the cladding, i.e., the air with a fluid to be detected, surrounding the all-pass ring resonator 1. The solid line 41 shows the refractive index with air without any other component around the ring resonator. The dashed line 42 shows the refractive index of the air containing the component to be detected around the ring resonator. The difference in refractive index due to the component is denoted Δn_{clad}.

FIG. 10b shows a schematic transmission spectrum of the all-pass ring resonator 1 in FIG. 9a. The solid line shows the transmission with air present around the waveguide resonator 1. The dashed line shows the transmission with air and a fluid present around the waveguide resonator 1. The wavelength shift due to the air containing the component to be detected is denoted Δλf. The dotted line 45 shows the transmission spectrum of the component to be detected, in which the three dips are due to three absorption lines, broadened due to temperature and pressure.

FIG. 10c shows a schematic transmission spectrum of the waveguide resonator 1 (FIG. 9a) when it is tuned. The tuning may be provided by changing the mode effective refractive index of the waveguide resonator 1, e.g., by changing the temperature of the waveguide resonator 1. The transmission without any tuning is shown with the solid line 46, while the dashed lines 47 illustrate the transmission with two different amounts of tuning denoted Δ×t due to tuning. The dotted line 45 shows the transmission spectrum of the component, in which the three dips are due to three absorption lines, broadened due to temperature and pressure. Thus, by tuning the resonance wavelength the dispersion and absorption of the fluid to be detected may be detected. The tuning allows measuring the dispersion of the fluid, i.e. the real part of the refractive index as a function of the wavelength, and adjusting the sensitivity of each single-wavelength measurement. The concentration of the component in the fluid can be derived from the dispersion and a calibration reference.

FIGS. 11a and 11 b illustrates a sensor device 8 in which the mode effective refractive index of the waveguide resonator 1 may be changed without changing the temperature of the waveguide resonator 1 as described above. FIG. 11b is a cross sectional view of the device in FIG. 11a. In the embodiment shown in FIGS. 11a and 11b an SOI wafer has been used to manufacture the sensor device 8. The sensor device 8 comprises a silicon substrate 10 onto which a silicon dioxide box layer 11 and a silicon device layer 12 are arranged. The substrate defines a substrate plane P. The bus waveguide 13 and the ring resonator 1 are arranged as ridge waveguides in the silicon device layer 12. The ring resonator 1 is arranged on a hinged membrane part 26. The membrane part 26 may be moved in relation to the silicon substrate 10 by applying an actuation voltage with a voltage actuator 30 between the silicon substrate 10 and the silicon device layer 12. The bending of the membrane part 26 depends on the voltage applied by between the silicon substrate 10 and the silicon membrane 5. A silicon rib 27 is arranged on the silicon membrane 5 adjacent to the waveguide resonator 1 when no voltage is applied between the silicon substrate 10 and the silicon membrane 5. When the voltage between the silicon substrate 10 and the silicon device layer 12 is increased the membrane 26 and the ring resonator 1 are bent in the direction of the arrow 49. The distance between the silicon rib 27 and the waveguide resonator 1 increases when the voltage is increased and the mode effective refractive index ring of the ring resonator 1 varies correspondingly. The hinged membrane part 26, the silicon rib 27 and the voltage actuator 30 constitutes means to modify the real part of the refractive index of the ring resonator 1. The arrow 50 in FIG. 11c illustrates how the resonance peaks 51 are moved to the left, i.e., to shorter wavelengths, when the voltage is increased. This is due to the decreasing effective refractive index of the ring resonator 1 when it is moved away from the silicon rib. FIG. 11d shows in cross section an enlarged part of the ring resonator 1 and the silicon rib 27. The electromagnetic field 52 around the ring resonator 1 is shown in FIG. 11d. As can be clearly seen the evanescent field part of the electromagnetic field 52, i.e., the electromagnetic field outside the ring resonator 1, has a varying interaction with the silicon rib 27 when the voltage is increased. This results in a decreased effective refractive index of the ring resonator 1.

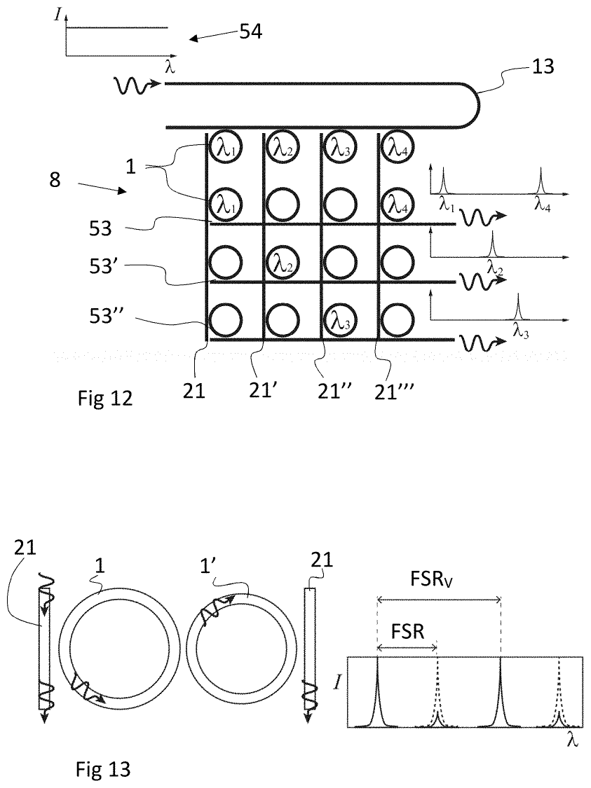

FIG. 12 illustrates schematically a sensor device 8 with a bus waveguide 13, a grid of multiple ring resonators 1, and multiple vertical routing waveguides 21, 21′, 21″, 21′″, and multiple horizontal detection waveguides 53, 53′, 53″, 53″. The input light 54 to the bus waveguide 13 is white light with a constant intensity I as a function of the wavelength λ. The first row of ring resonators comprise four ring resonators tuned to wavelengths of λ₁, λ₂, λ₃, and λ₄, respectively, which will couple light at their respective tuning wavelengths to the respective vertical routing waveguides 21, 21′, 21″, 21′″. This means that the first wavelength λ₁ will be coupled into the first vertical routing waveguide 21, the second wavelength λ₂ will be coupled into the second vertical routing waveguide 21′, the third wavelength λ₃ will be coupled into the second vertical routing waveguide 21″, and the fourth wavelength λ₄ will be coupled into the fourth vertical routing waveguide 21′″. On the second row the first ring resonator is tuned to the first wavelength λ₁ and will couple the first wavelength Xi to the first horizontal detection waveguide 53. On the second row the fourth ring resonator is tuned to the fourth wavelength λ₄ and will couple the fourth wavelength λ₄ from the fourth vertical waveguide 21′″ to the first horizontal detection waveguide 53. As a result the output from the first horizontal detection waveguide 53 will be the first wavelength Xi and the fourth wavelength λ₄. On the third row the second ring resonator is tuned to the second wavelength λ₂ and will couple the second wavelength Xi from the second vertical routing waveguide 21′ to the second horizontal detection waveguide 53. As a result the output from the second horizontal detection waveguide 53′ will be the second wavelength λ₂. On the fourth row the third ring resonator is tuned to the third wavelength λ₃ and will couple the third wavelength λ₃ from the third vertical waveguide 21′ to the third horizontal detection waveguide 53. As a result the output from the third horizontal detection waveguide 53″ will be the third wavelength λ₃.

FIG. 13 shows a sensor device 8′ according to an alternative embodiment of the present invention. The sensor device 8′ comprises a bus waveguide 13, a detection waveguide 21 and two consecutive ring resonators 1, 1′ which couples light from the bus waveguide 13 to the detection waveguide 21. The first ring resonator 1 has a first radius and the second ring resonator 1′ has a second radius which is different from the first radius. The light in the detection waveguide will have main peaks which are separated with the Vernier free spectral range FSRᵥ, which is larger than the single-resonator FSR.

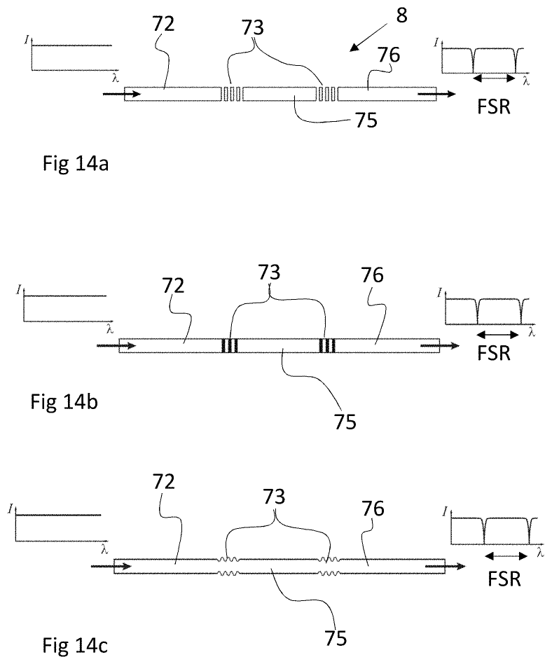

FIG. 14 shows a sensor device 8 according to an alternative embodiment of the present invention. The sensor device 8 comprises an input waveguide 72, two reflectors 73 in the form of a diffractive or Bragg grating, a cavity waveguide 75 between the two reflectors 73 and an output waveguide 76. The sensor device functions as a Fabry-Perot interferometer. With white light as input the output light will show dips in correspondence of the cavity resonances, which are separated by the free spectral range FSR of the cavity. In FIG. 14a the gratings are formed by gaps in the waveguide 72. The gaps can have the same or different dimensions as the waveguide 72. In FIG. 14b the reflectors 73 are formed as gratings formed by elements of a material of a composition other than the waveguide's composition placed on top of the waveguide 72. In FIG. 14c the reflectors 73 are formed as gratings formed by corrugations, indentations, or protrusions on the sidewalls of the waveguide 72.

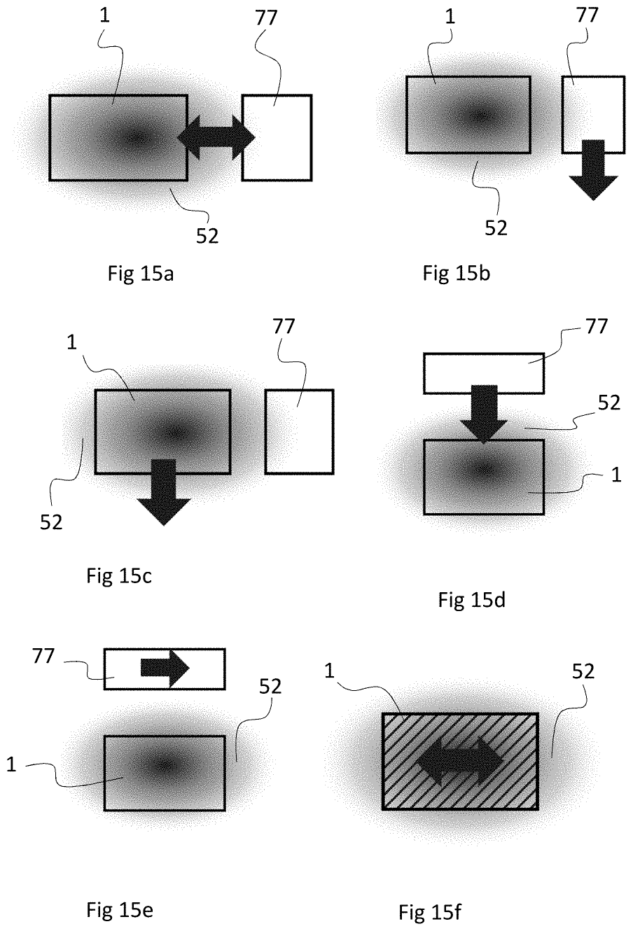

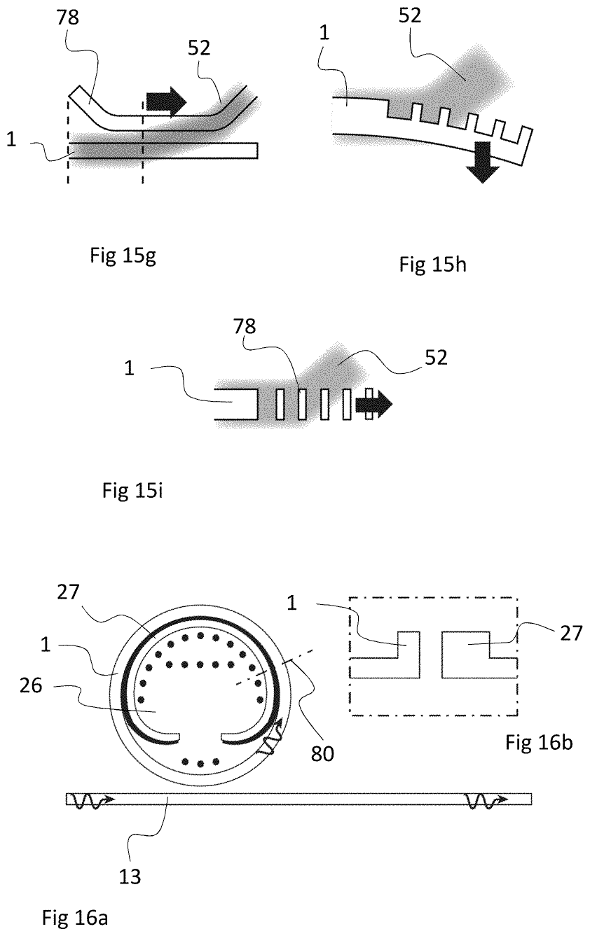

FIG. 15 illustrates different micro-electro-mechanical systems, MEMS, tuning methods for tuning the mode effective index of a waveguide. FIGS. 15a-15e are cross-sectional views of a waveguide 1 and a waveguide-like structure 77. The waveguide like structure is similar to the silicon rib 27 in FIG. 11. FIG. 15f is a cross-sectional view of a waveguide 1. An electromagnetic wave 52 is shown in all FIGS. 15a-15i.

FIG. 15a illustrates a phase shifting method where the effective mode index is varied by moving the waveguide 1 and a waveguide-like structure 77 in-plane closer or further apart by electrostatic actuation, as is indicated by the arrow.

FIG. 15b illustrates a phase shifting method where the effective mode index is varied by moving the waveguide-like 77 structure downwards by electrostatic actuation, as is indicated by the arrow. The waveguide 1 and the waveguide-like structure 77 are in-plane, but the movement is out-of-plane.

FIG. 15c illustrates a phase shifting method where the effective mode index is varied by moving the waveguide 1 downwards by electrostatic actuation, as is indicated by the arrow. The waveguide 1 and the waveguide-like structure 77 are in-plane, but the movement is out-of-plane.

FIG. 15d illustrates a phase shifting method where the effective mode index is varied by moving the waveguide-like structure 77 downwards towards the waveguide 1 by electrostatic actuation, as is indicated by the arrow. The waveguide 1 and the waveguide-like structure 77 are out-of-plane.

FIG. 15e illustrates a phase shifting method where the effective mode index is varied by moving the waveguide-like structure sideways by electrostatic actuation as is indicated by the arrow. The waveguide 1 and the waveguide-like structure 77 are out-of-plane.

FIG. 15f illustrates a phase shifting method where the effective mode index is varied by creating strain in the piezoelectric material of the waveguide 1 by piezoelectric actuation.

FIG. 15g illustrates in a top view a phase shifting method where the effective mode index is varied by changing the effective length of the waveguide 1 using a movable directional coupler 78.

FIG. 15h illustrates in a side view a tunable grating 79 at the end of a waveguide 1 where the tuning is achieved by bending the grating 79.

FIG. 15h illustrates in a side view a tunable grating 79 where the tuning is achieved by changing the period of the grating 79 by in-plane actuation.

FIG. 16a illustrates in a top view a sensor device 8 in which the effective refractive index of the waveguide resonator 1 may be changed without changing the temperature of the waveguide resonator 1 which is a variant of the sensor shown in FIG. 11. In FIG. 16a the silicon rib 27 is arranged on the membrane 26. The silicon rib 27 may be moved in relation to the waveguide resonator 1 by bending the membrane 26. FIG. 11b shows in cross section along the line 80 the waveguide 1 and the is a cross sectional view of the device in FIG. 11a. The bus waveguide 13 is fixed in relation to the ring resonator 1.

In the following refractive index sensing and dispersion spectroscopy will be described to explain the physics involved in the function of the sensor device.

Refractive indices are complex numbers. However, the term ‘refractive index’ is often used to refer solely to the real part n, while the imaginary part K is referred to as ‘absorption’, although they are not the same thing but related according to:

$$α = \frac{4 π κ}{{λ}_{0}} \qquad ( 1 )$$

‘Refractive index sensing’, thus, commonly indicates the measurement of the real part of the index, rather than the absorption. Moreover, since the wavelength-dependent behaviour of the real part of the refractive index is called dispersion, the measurement of the refractive index over a range of wavelengths is called dispersion spectroscopy.

The real part n and the absorption, hence the imaginary part, of any refractive index are not independent from each other, but due to the principle of causality [2] they are related through the Kramers-Kronig relation

$$n ( ω ) = 1 + \frac{c}{π} {\int }_{0}^{∞} \frac{α ( {ω}^{′} )}{{ω}^{′2} - {ω}^{2}} d {ω}^{′} . \qquad ( 2 )$$

This means that, if there is a strong variation in the absorption of a material, there is also a variation in the real part of its refractive index. FIG. 1 shows the real part of the refractive index of mixtures of nitrogen (N2) and CO2 in different concentrations, calculated from the well-known wavelength-dependent absorption coefficients around 4.23 μm wavelength.

A device well suited for the detection of small changes in the refractive index of materials is the photonic ring resonator. A photonic ring resonator, depicted in FIG. 6 a, is a closed-loop photonic waveguide. Light is coupled in and out of the ring via an adjacent waveguide, called bus waveguide. Simply described, when two waveguides are in close proximity their modes are not independent, but together form so-called supermodes that span across both waveguides. Thanks to the supermodes, under certain geometrical conditions, optical power propagating in one waveguide can transfer to the other waveguide. Such a photonic component is called a directional coupler. In this way, light can transfer from the bus waveguide to the ring resonator and vice versa. Therefore, part of the light propagating in the bus waveguide couples into the ring, travels along the loop, and reaches the directional coupler again. At this point, the light has accumulated a phase shift that depends on the mode's effective refractive index, on the ring length, and on the wavelength. If the phase shift is equal to a multiple of 2n, i.e. when the effective wavelength of the light fits a whole number of times in the optical length of the ring,

$${λ}_{r} = \frac{{n}_{eff} L}{m} , \qquad ( 3 )$$

$$m = 1 , 2 , 3 , … ,$$

the ring is on resonance and the light keeps propagating in it. The resonance is revealed by a decrease in the light output from the bus waveguide, as shown in FIG. 6. The transmission of a ring resonator device is described by

$$T = \frac{{a}^{2} - 2 ra cos ϕ + {r}^{2}}{1 - 2 ra cos ϕ + {r}^{2} {a}^{2}} , \qquad ( 4 )$$

where r is the ring coupling coefficient of the directional coupler as shown in FIG. 6,) and a is the single-pass transmission coefficient, which accounts for the coupling loss and for the propagation loss occurring in the ring.

Relevant characteristics of a ring resonator are the free spectral range (FSR), i.e. the spectral spacing between adjacent resonances, the resonance bandwidth, or full width at half maximum (FWHM) of the resonance dip, and the quality factor (Q), i.e. the ratio between the energy stored in the ring and energy dissipated per cycle, which is usually approximated as Q=λᵣ/FWHM.

Any change in the effective index of the ring waveguide mode modifies the phase shift of the light in the ring and, consequently, the resonance condition. This translates into a shift in the resonance wavelength. Assuming a generic perturbation p affecting the effective refractive index, the resonance shift is

$${Δλ}_{r} = - p \frac{\partial {n}_{eff}}{p} \frac{\partial λ}{\partial {n}_{eff}} . \qquad ( 5 )$$

The shift can be observed in the ring transmission spectrum (FIG. 2 b) and exploited to detect refractive index changes in either or both the core and cladding materials. Therefore, the measurement sensitivity of the ring resonator is the shift in resonance wavelength due to a change in the core or cladding material refractive index:

$$S = \frac{\partial {λ}_{r}}{\partial {n}_{core / clad}} . \qquad ( 6 )$$

Dispersion Spectroscopy with a Microring Resonator

The above description presents the on-chip refractive index sensing of a CO2 absorption peak using a Si photonic mid-IR tunable racetrack microring resonator. The measurement exploits the link between the real and imaginary parts of the refractive index of the air cladding, described by the Kramers-Kronig relation (as discussed above), to achieve dispersion spectroscopy of a CO2 fundamental absorption peak in the mid-IR.

The waveguide resonator 1, shown in FIG. 3, as well as the bus waveguide, are fully suspended Si rib waveguides, 220 nm thick and 2 μm wide, supported by a continuous 70 nm-thick Si membrane 3 μm above the silicon substrate 10. The coupling gap between the waveguide resonator land the bus waveguide 13 is 1 μm and the waveguide resonator 1 is 935 μm long. The bus waveguide and the waveguide resonator 1 are single-mode at 4.23 μm wavelength, and the supported fundamental TE mode features an evanescent field ratio (EFR) of 67% and an external confinement factor r of 50%.

The ring resonator features an FSR of 6.6 nm and a Q factor of 8000. The resonance of the waveguide resonator 1 closest to the CO2 absorption peak at 4234.7 nm wavelength is tuned across the peak by varying the temperature of the chip with a Peltier cooling element. This allows varying the overlap between the resonance and absorption peak. When flushing the waveguide resonator 1 with CO2 diluted in N2 in concentrations of 0.1%, 0.5%, and 1%, the ring resonance shifts from its initial position due to the change in the cladding's refractive index, according to eq. 5, as shown in FIG. 5. By performing the gas sensing experiment for different initial resonance positions, set by thermally tuning the ring, the cladding's refractive index is measured across the wavelength range probed by the resonance of the waveguide resonator 1, and thus the dispersion of the gas cladding is characterized.

On-chip gas dispersion spectroscopy.

Dispersion spectroscopy of gases has been recently shown using large-scale free-space gas cells and complex detection schemes.

The high external confinement factor r of 50% provides a high sensitivity of the light mode to the gas. The measured CO2 concentration of 1000 ppm is 5 times lower than that achieved by previously reported microring-based absorption sensing of a trace gas.

The main advantages of dispersion spectroscopy over absorption spectroscopy are the linear relation between the shift in the dispersion spectrum and the analyte concentration and the immunity to intensity fluctuations.

Absorption spectroscopy requires the direct measurement of intensity changes in the optical signal. This can be problematic if the signal changes are close to the noise level, if the intensity variations exceed the dynamic range of the photodetector, and if the optical power provided by the source fluctuates. Moreover, for strongly absorbing analytes, the Beer-Lambert law is not linear. The dispersion spectrum, instead, varies linearly with the analyte concentration also at high concentrations, and measurements of phase variations are much less affected by possible photodetector nonlinearities and intensity fluctuations. Operating in the mid-IR offers the possibility to probe the fundamental absorption lines of trace gases. For CO2 sensing this is particularly beneficial, as its fundamental absorption band does not overlap with those of other commonly present gases such as water vapor. Furthermore, the ability to tune the ring resonator allows the accurate control of the resonance position, e.g. to match specific absorption lines. These two aspects together mitigate the lack of specificity of refractive index sensing.

Absorption gas sensing performed with a narrowband light source yields extremely high specificity. However, it is possible to implement absorption measurements also with broadband sources, as done, e.g. with NDIR sensors.

Dispersion spectroscopy, instead, requires high spectral resolution, which can be achieved either by using a tunable narrow-band source, such as a laser, or by combining a broadband source with tunable spectral filters. The described embodiments may be amended in many ways without departing from the scope of the present application which is limited only by the appended claims.

1. A sensor device comprising:
a planar substrate defining a substrate plane; and
an electromagnetic waveguide forming a waveguide resonator and extending in a length direction in a waveguide resonator plane parallel to the substrate plane,
wherein the electromagnetic waveguide is supported on the substrate by a support structure, and
wherein the electromagnetic waveguide has a width in the waveguide resonator plane in a direction perpendicular to the length direction, and a height out of the waveguide plane in a direction perpendicular to the length direction.

2. The sensor device according to claim 1, wherein the waveguide resonator is free hanging along any portions along the length direction.

3. The sensor device according to claim 1, wherein the vacuum wavelength of the electromagnetic wave is within the range of 0.1-100 μm.

4. The sensor device according to claim 1, further comprising means to modify the real part of the effective refractive index of a waveguide mode of the waveguide resonator.

5. The sensor device according to claim 1, wherein a source of electromagnetic radiation is placed on the same substrate to couple electromagnetic radiation to the waveguide resonator.

6. The sensor device according to claim 1, wherein a detector of electromagnetic radiation is placed on the same substrate to couple electromagnetic radiation from the waveguide resonator.

7. The sensor device according to claim 1, wherein the mode volume of a resonant mode of the waveguide resonator is below 1 mm³.

8. The sensor device according to claim 1, further comprising a second electromagnetic waveguide forming a bus waveguide, extending in a length direction in a waveguide plane parallel to the substrate plane and placed to electromagnetically couple the bus waveguide and the waveguide resonator.

9. The sensor device according to claim 8, wherein the distance between the bus waveguide and the waveguide resonator is no more than 1 μm.

10. A method of analyzing a component in a fluid comprising:
providing a sensor device according to claim 1;
providing the fluid in contact with the waveguide resonator;
coupling an electromagnetic wave into the waveguide resonator;
allowing the electromagnetic wave to interact with the fluid in a region of an evanescent wave of the electromagnetic wave around the waveguide resonator;
detecting the electromagnetic wave circulating in the waveguide resonator; and
detecting a component in the fluid based on the detected electromagnetic wave.

11. The method according to claim 10, wherein the real part of the effective refractive index of the waveguide mode of the waveguide resonator is varied to modify a resonance wavelength of the waveguide resonator and thus change the spectral distance of a resonance wavelength of the waveguide resonator from a spectral absorption line of the component to be detected.

12. The method according to claim 10, wherein the observed spectral position of a resonance wavelength of the waveguide resonator is used a as measure of real part of the refractive index of the component in the fluid, and the spectral width of a resonance is used as a measure of the imaginary part of the refractive index of the component in the fluid, to determine the complex refractive index of the component in the fluid.

13. The method according to claim 10, wherein the observed spectral distance of a resonance wavelength of the waveguide resonator from a spectral absorption line of the component to be detected is used as a measure of the concentration of the component in the fluid.

14. The method according to claim 10, wherein the observed spectral width of a resonance wavelength of the waveguide resonator as a function of distance from a spectral absorption line of the component to be detected is used as a measure of the concentration of the component in the fluid.
